(19) United States
(12) Patent Application Publication
(10) Pub. No.: US 2018/0160247 A1
(43) Pub. Date: Jun. 7, 2018

(54) MANUFACTURING METHOD OF A SPEAKER VIBRATING DIAPHRAGM BY CONTROLLING A RATIO OF FIBER MATERIALS

(71) Applicant: Hiroshi OHARA, Taoyuan City (TW)

(72) Inventor: Hiroshi OHARA, Taoyuan City (TW)

(21) Appl. No.: 15/465,952

(22) Filed: Mar. 22, 2017

(30) Foreign Application Priority Data
Dec. 6, 2016 (TW) 105140159

(51) Int. Cl. H04R 31/00; D03D 15/00; B29C 43/00; B29C 43/02

(52) U.S. Cl. CPC H04R 31/003; D03D 15/0027; B29K 2105/256; B29C 43/021; B29C 43/02; B29C 43/003

(57) ABSTRACT

The invention discloses a manufacturing method of a speaker vibrating diaphragm by controlling a ratio of fiber materials, the method comprising the steps of: (A) fabric provision: providing a fabric interwoven by a plurality of warps and a plurality of wefts; (B) impregnation: impregnating the fabric in a resin solution; (C) drying: drying the fabric impregnated with resin solution; (D) formation: pressing the dried resin-impregnating fabric to form a predetermined shape; and (E) cutting: cutting the formed speaker vibrating diaphragm from the fabric. Each of the plurality of warps and each of the plurality of wefts of the fabric has an individual yarn count and material composition. By controlling a combination of the yarn counts of the plurality of warps and the plurality of wefts, a total number of threads and a material composition ratio of the warps and wefts required for the vibrating diaphragm are achieved.

### CROSS-REFERENCE TO RELATED APPLICATION

This application claims the priority of Taiwanese patent application No. 105140159, filed on Dec. 6, 2016, which is incorporated herewith by reference.

### BACKGROUND OF THE INVENTION

### 1. Field of the Invention

The present invention relates generally to a manufacturing method of a speaker vibrating diaphragm, and more particularly, to a manufacturing method of a speaker vibrating diaphragm by controlling the ratio of fiber material.

### 2. The Prior Arts

Referring to FIG. 1, a typical moving coil 10 includes a power system, a cone paper 11 and a suspension. The power system further includes a magnet 15, a pole piece, a basket assembly and a voice coil 14. The cone paper 11, which is a vibrating diaphragm for moving air, is typically a sound cone in conical shape or hemispherical shape. The suspension is composed of a damper 12 and a connecting member 13 etc., for drawing a directional movement of the vibrating diaphragm. The operation principle is that when current flows through the voice coil 14, an electromagnetic field perpendicular to the magnetic field of the permanent magnet 15 of the speaker is generated, forcing the voice coil to move within the gap (the gap between the voice coil 14 and the magnet 15). The mechanic force generated by the movement allows the cone paper 11 attached on the voice coil 14 to produce a perpendicular and up-down movement (vibration), so that the air is vibrated to make a sound to be perceived by human ears, thereby implementing a conversion of electric energy to sound energy.

The variety of nonmetal parts inside the conventional speaker 10, such as the cone paper 11, the damper 12 etc., are manufactured by original fabrics; this is because the original fabrics processed by special treatment possesses an appropriate elasticity and intensity that fulfill the function requirements for operating the speaker. These nonmetal parts are collectively called speaker vibrating diaphragms. A conventional method for manufacturing speaker vibrating diaphragms includes steps of resin impregnation, drying, formation, and cutting, to form the final product of speaker vibrating diaphragms.

Although the speaker vibrating diaphragms only accounts for a very small percentage of the cost of the overall speaker, the speaker vibrating diaphragms play critical roles in affecting the sound quality of the speaker. As a result, the manufacturing method of high-quality speaker vibrating diaphragms which fulfill various environmental requirements becomes very important.

Specifically, the fabric material used for manufacturing a conventional speaker vibrating diaphragm is the essential and fundamental structure of the speaker vibrating diaphragm. However, it is rare that techniques in textile industry are applied to the manufacture of the speaker vibrating diaphragm. As a result, the requirements such as the composition of fabric materials, the ratio of number of threads and the like for manufacturing the speaker vibrating diaphragm are restricted within the conventional process performed by traditional textile factories. For example, when manufacturing a speaker vibrating diaphragm, if the speaker vibrating diaphragm is manufactured by a fabric composed of a plurality of materials, it is first required to mix and twist the plurality of raw materials with a specific ratio into yarns as warps and wefts for weaving, so that a fabric with a specific material ratio and yarn count can be obtained. Since this manufacturing method requires mixing and twisting materials into yarns, a high manufacturing cost is required.

### SUMMARY OF THE INVENTION

A primary objective of the present invention is to provide a manufacturing method of a speaker vibrating diaphragm by controlling a ratio of fiber materials, so that the requirement of conventional fabric for manufacturing a speaker vibrating diaphragm is alleviated and the processing expense of weaving the fabric is reduced.

In order to achieve the above objective, the present invention provides a manufacturing method of a speaker vibrating diaphragm by controlling the ratio of fiber materials, the method includes the steps of: (A) fabric provision: providing a fabric interwoven by a plurality of warps and a plurality of wefts; (B) impregnation: impregnating the fabric in a resin solution; (C) drying: drying the fabric impregnated with resin solution; (D) formation: pressing the dried resin-impregnating fabric to form a predetermined shape; and (E) cutting: cutting the formed speaker vibrating diaphragm from the fabric. Wherein, each of the plurality of warps of the fabric has an individual yam count and material composition, and each of the plurality of wefts of the fabric has individual yarn count and material composition. A total number of threads and a material composition ratio of the warps and wefts required for the speaker vibrating diaphragm are achieved by controlling a combination of the yarn counts of the plurality of warps and the plurality of wefts.

Preferably, each of the plurality of warps is a single yam composed of 100% of a single material.

Preferably, each of the plurality of wefts is a single yarn composed of 100% of a single material.

Preferably, the plurality of warps are composite yarns twisted by using at least two types of materials.

Preferably, the plurality of wefts are composite yarns twisted by using at least two types of materials.

Preferably, the plurality of warps have at least one kind of yarn count and the warps are alternately arranged in a predetermined order.

Preferably, the plurality of wefts have at least one kind of yarn count and the wefts are alternately arranged in a predetermined order.

Preferably, the material of the plurality of warps is one or a combination selected from a group consisting of cotton, polyester, aramid, acrylic, rayon, and silk.

Preferably, the material of the plurality of wefts is one or a combination selected from a group consisting of cotton, polyester, aramid, acrylic, rayon, and silk.

The present invention is thereby beneficial in alleviating the requirement of conventional fabric for manufacturing conventional speaker vibrating diaphragms and reducing the processing expense of weaving fabric materials.

### BRIEF DESCRIPTION OF THE DRAWINGS

FIG. 1 is a schematic diagram illustrating the structure of a conventional speaker;

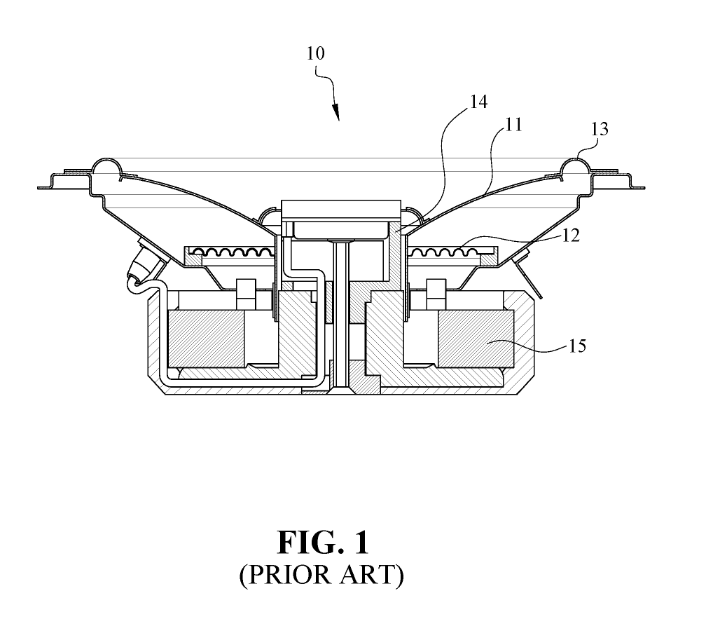

FIG. 2 is a perspective view of a damper of the speaker;

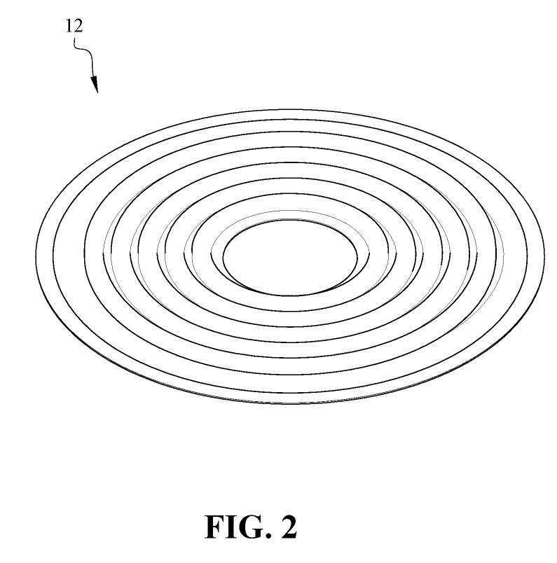

FIG. 3 is a flow diagram of the processing steps of the present invention;

FIG. 4 is illustrates the manufacturing process of the present invention;

FIG. 5A is a partial enlarged view of Embodiment 1;

FIG. 5B is a partial enlarged view of Embodiment 2;

FIG. 5C is a partial enlarged view of Embodiment 3; and

FIG. 5D is a partial enlarged view of Embodiment 4.

### DETAILED DESCRIPTION OF THE PREFERRED EMBODIMENT

The accompanying drawings and reference symbols are included to illustrate embodiments of the present invention so that the invention can be implemented by a skilled person.

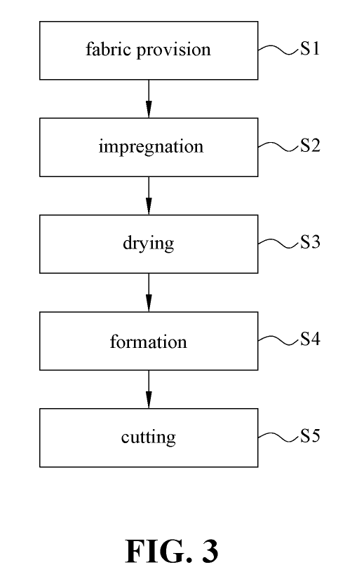

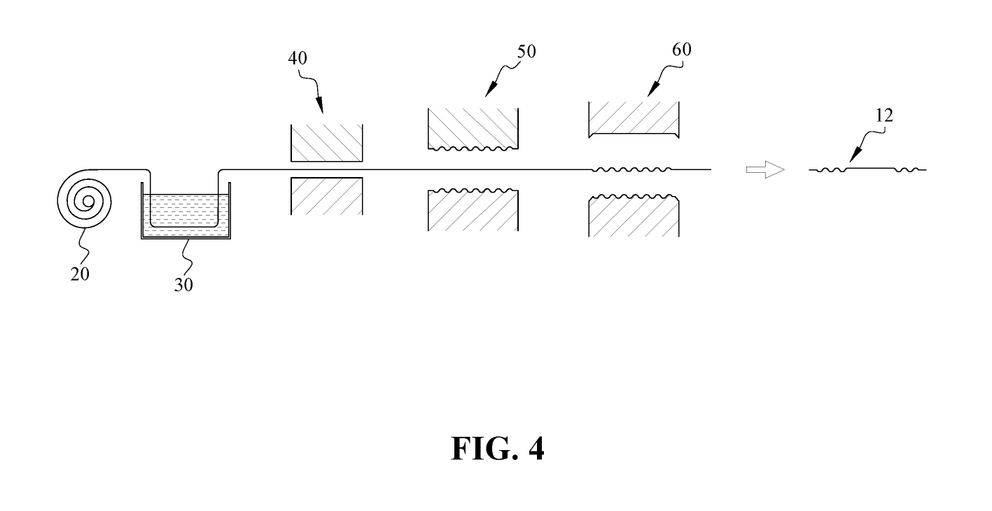

Referring to FIG. 3 and FIG. 4, which show a flow diagram and a manufacturing process of the present invention respectively. The steps are illustrated hereafter.

Fabric provision (step S1): a fabric 20 is provided. The fabric 20 is interwoven by a plurality of warps and a plurality of wefts (not shown). Each of the plurality of warps of the fabric 20 has an individual yarn count and material composition, and each of the plurality of wefts of the fabric has an individual yarn count and material composition. By controlling a combination of the yarn counts of the plurality of warps and the plurality of wefts, a total number of threads and a material composition ratio of the warps and wefts required for the speaker vibrating diaphragm are achieved

Impregnation (step S2): the fabric 20 is impregnated in a resin solution 30. In general, resin component can be selected from one or a combination of a group consisting of phenolic resin, epoxy resin, and polyester resin, or from other resin materials possessing with a same property.

Drying (step S3): the fabric 20 impregnated with resin solution is dried. More specifically, the fabric 20 is transferred to a drying device 40 for drying the resin on the fabric 20, such that the fabric 20 is provided with appropriate hardness, elasticity and toughness.

Formation (step S4): after drying the fabric 20 impregnated with resin solution, the fabric 20 is pressed to form a predetermined shape. More specifically, the fabric 20 is transferred to a heat pressing formation device 50 which includes a heating device and a formation mold (comprised of an upper mold and a lower mold). The formation mold is heated to a predetermined temperature and presses the fabric 20 from up and down, such that a predetermined shape of the speaker vibrating diaphragm is formed after pressuring and heating the fabric 20.

The formation condition and temperature are determined based on the composition of the fabric and resin solution. In general, the formation temperature of cotton fibers is 245° C. ±30° C.; the formation temperature of polyester fibers is 200° C. ±30° C.; and the formation temperature of aramid fibers is 240° C. ±35° C.

Cutting (step S5): the formed speaker vibrating diaphragm is cut from the fabric 20 to obtain a speaker vibrating diaphragm 12. More specifically, the fabric 20 is transferred to a cutting device 60 to cut the speaker vibrating diaphragm with a predetermined shape from the fabric 20 to obtain the speaker vibrating diaphragm 12. The speaker vibrating diaphragm 12 formed in the figure is a damper, yet other elements of vibrating system such as the cone paper or the connecting member can be manufactured via the same process.

### Embodiment 1

As for the conventional manufacturing method, when a speaker damper composed of 50% polyester fibers and 50% rayon fibers with a yarn count of 20 is to be manufactured, the conventional manufacturing method has to mix and twist two materials of fibers with a specific ratio into yarns first. Then, the yarns are used as warps and wefts to be woven to obtain a fabric material with a specific material ratio and yarn count. Since this manufacturing method first requires mixing and twisting polyester fibers and rayon fibers into yarns, the process of mixing and twisting requires high processing expense.

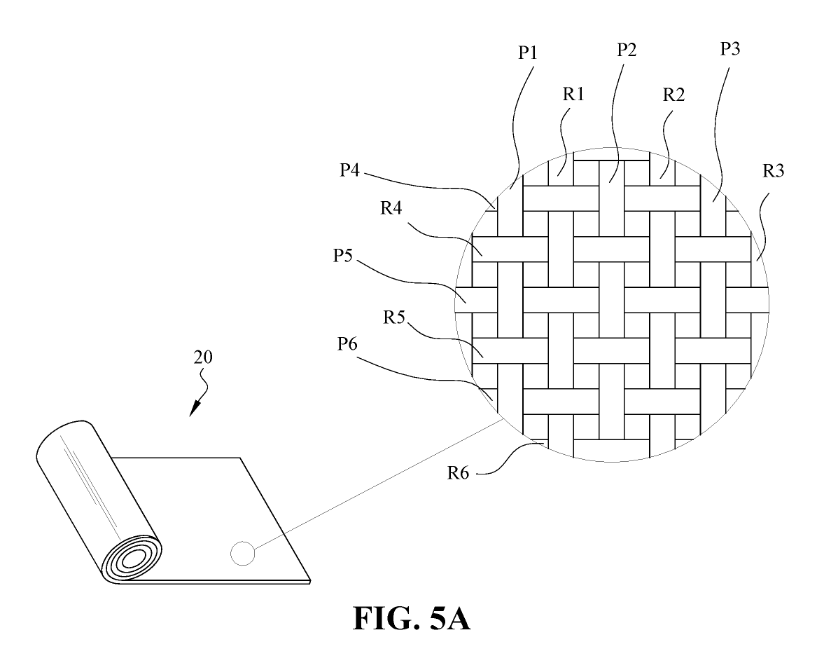

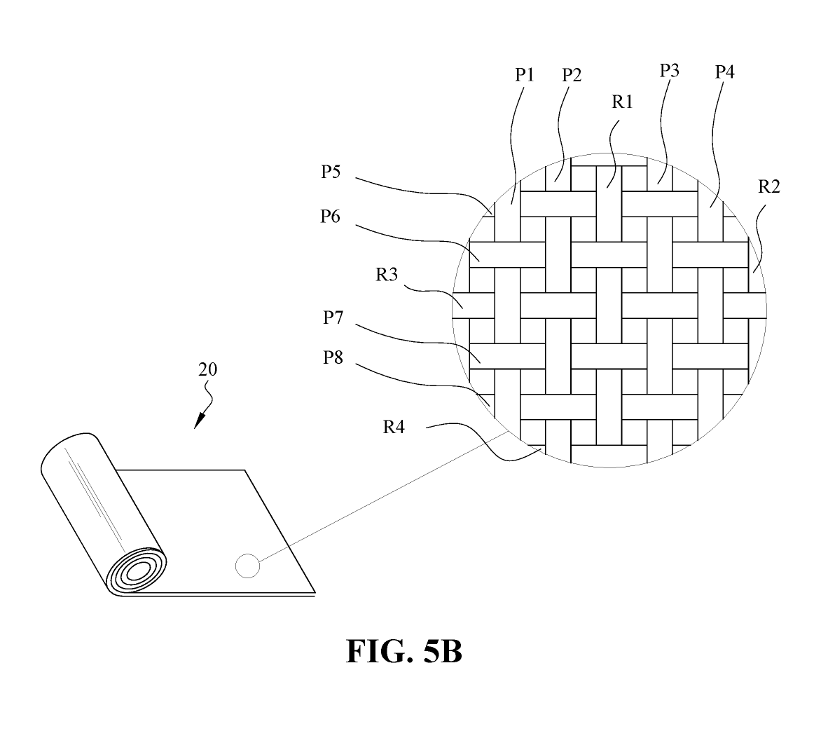

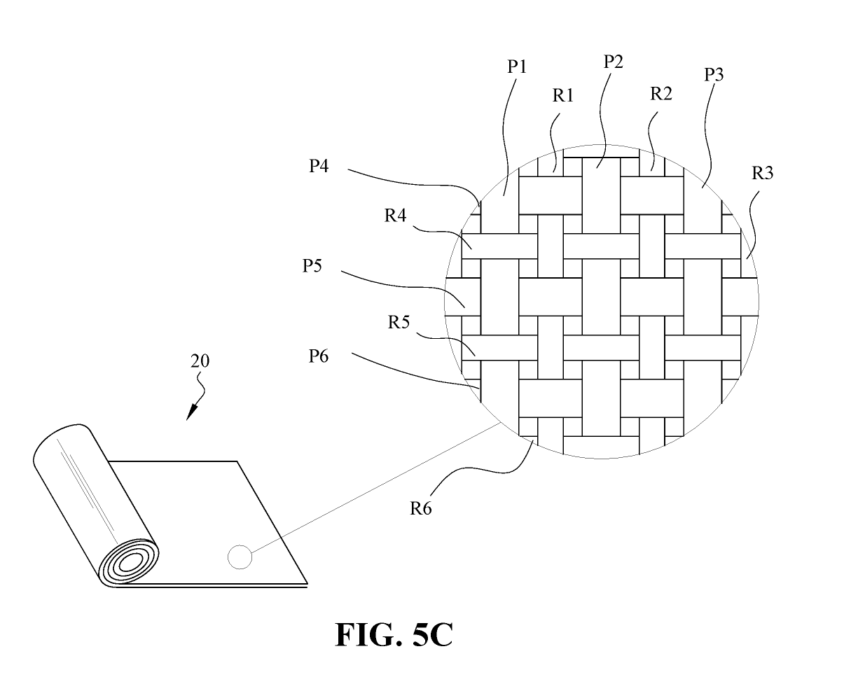

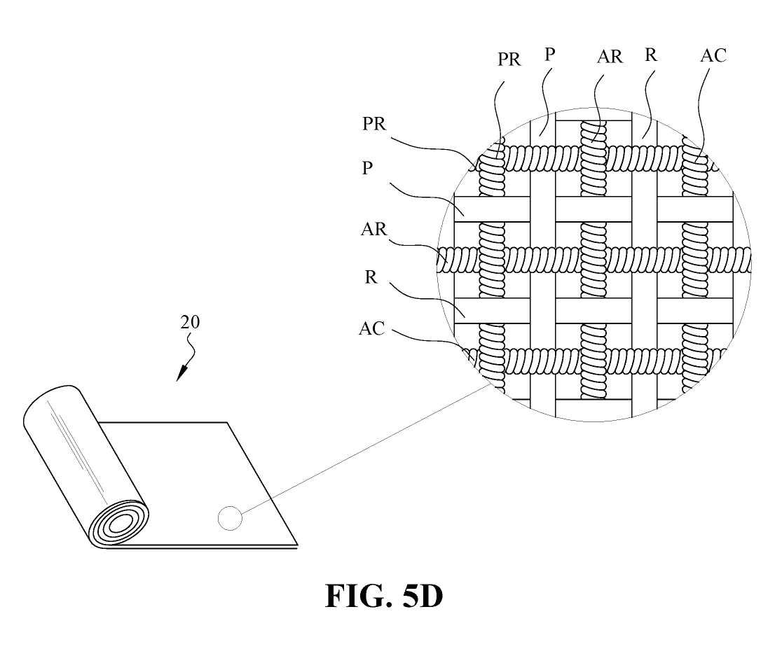

However, in the step of fabric provision of the manufacturing method in the present invention, the total number of threads and the material composition ratio of warps and wefts required by the speaker vibrating diaphragm are achieved by controlling the combination of yarn counts of the plurality of warps and the plurality of wefts of the fabric. Referring to FIG. 5A, FIG. 5A shows a partial enlarged view of Embodiment 1. Taken embodiment 1 as the example, the partial enlarged view of the fabric 20 shows that the warps are composed by sequentially and alternatively arranging 100% polyester fibers P1, P2, P3 with yarn counts of 20 and 100% rayon fibers R1, R2, R3 with yarn counts of 20, and the wefts are composed by sequentially and alternatively arranging 100% polyester fibers P4, P5, P6 with yarn counts of 20 and 100% rayon fibers R4, R5, R6 with yarn counts of 20 (as shown in Table 1).

According to the improved manufacturing method of Embodiment 1, mass produced, low cost and easily available 100% polyester fibers and 100% rayon fibers can be used directly as warps and wefts to be arranged alternatively and woven to fabric material as the fabric for manufacturing the speaker vibrating diaphragm. As a result, the processing expense of mixing and twisting different raw materials with a specific ratio into a yarn can be omitted. In the industry of speaker element which has low gross margin and consumes a great amount of manpower and time, the manufacturing method is novel and it greatly reduces processing cost and time required for production.

TABLE 1
Fiber composition and yarn counts of the warps and wefts in Embodiment 1

| warps | Fiber material/ | Polyester | Rayon | Polyester | Rayon | Polyester | Rayon |
|---|---|---|---|---|---|---|---|
| | Number | Fiber | Fiber | Fiber | Fiber | Fiber | Fiber |
| | | P1 | R1 | P2 | R2 | P3 | R3 |
| | Yarn count (S) | 20 | 20 | 20 | 20 | 20 | 20 |
| wefts | Fiber material/ | Polyester | Rayon | Polyester | Rayon | Polyester | Rayon |
| | Number | Fiber | Fiber | Fiber | Fiber | Fiber | Fiber |
| | | P4 | R4 | P5 | R5 | P6 | R6 |
| | Yarn count (S) | 20 | 20 | 20 | 20 | 20 | 20 |

### Embodiment 2

If a speaker damper composed of ⅔ polyester fibers and ⅓ rayon fibers with a yarn count of 20 is to be manufactured, the conventional manufacturing method first requires preparing two materials of fibers, mixing and twisting the fibers with a specific ratio of 2:1 into yarns, and using the yarns as warps and wefts to be woven to obtain a fabric material with a specific material ratio and yarn count. This conventional manufacturing method also requires the process of mixing and twisting with a high manufacturing cost.

Referring to FIG. 5B, FIG. 5B shows a partial enlarged view of Embodiment 2. In Embodiment 2, the threads ratio and the arrangement order of the warps and wefts can be altered to obtain the required total number of threads and material composition ratio of the warps and wefts. Taking Embodiment 2 as the example, the warps are composed by sequentially and alternatively arranging 100% polyester fibers P1, P2, P3, P4 with yarn counts of 20 and 100% rayon fibers R1, R2 with yarn counts of 20, and the wefts are composed by sequentially and alternatively arranging 100% polyester fibers P5, P6, P7, P8 with yarn counts of 20 and 100% rayon fibers R3, R4 with yarn counts of 20 (as shown in Table 2).

TABLE 2
Fiber composition and yarn counts of the warps and wefts in Embodiment 2

| | | | | | | | |
|---|---|---|---|---|---|---|---|
| warps | Fiber | Polyester | Polyester | Rayon | Polyester | Polyester | Rayon |
| | material/ | Fiber | Fiber | Fiber | Fiber | Fiber | Fiber |
| | Number | P1 | P2 | R1 | P3 | P4 | R2 |
| | Yarn count | 20 | 20 | 20 | 20 | 20 | 20 |
| | (S) | | | | | | |
| wefts | Fiber | Polyester | Polyester | Rayon | Polyester | Polyester | Rayon |
| | material/ | Fiber | Fiber | Fiber | Fiber | Fiber | Fiber |
| | Number | P5 | P6 | R3 | P7 | P8 | R4 |
| | Yarn count | 20 | 20 | 20 | 20 | 20 | 20 |
| | (S) | | | | | | |

### Embodiment 3

Furthermore, a speaker damper composed of ⅔ polyester fibers and ⅓ rayon fibers with a yarn count of 20 can be achieved by adjusting fibers with different yarn counts.

Referring to FIG. 5C, FIG. 5C shows a partial enlarged view of Embodiment 3. In Embodiment 3, a speaker damper with required material composition ratio is obtained by alternating yarn counts of part of the warps and wefts. For example, if a speaker vibrating diaphragm composed of ⅔ polyester fibers and ⅓ rayon fibers with a yarn count of 20 is to be manufactured, the warps can be composed by sequentially and alternatively arranging 100% polyester fibers P1, P2, P3 with yarn counts of 20 and 100% rayon fibers R1, R2, R3 with yarn counts of 40, and the wefts can be composed by sequentially and alternatively arranging 100% polyester fibers P4, P5, P6 with yarn counts of 20 and 100% rayon fibers R4, R5, R6 with yarn counts of 40 (as shown in Table 3).

By this way of arranging the warps and wefts with different yarn counts and material compositions, the required specific material composition ratio can be achieved. In Embodiment 3, fibers composed of 100% of a single material are used with combinations of different yam counts and material combinations to achieve the same object. As a result, the process of mixing and twisting threads can be omitted and high expenses thereof can be reduced.

TABLE 3
Fiber composition and yarn counts of the warps and wefts in Embodiment 3

| warps | Fiber material/ | Polyester | Rayon | Polyester | Rayon | Polyester | Rayon |
|---|---|---|---|---|---|---|---|
| | Number | Fiber | Fiber | Fiber | Fiber | Fiber | Fiber |
| | | P1 | R1 | P2 | R2 | P3 | R3 |
| | Yarn count (S) | 20 | 40 | 20 | 40 | 20 | 40 |
| wefts | Fiber material/ | Polyester | Rayon | Polyester | Rayon | Polyester | Rayon |
| | Number | Fiber | Fiber | Fiber | Fiber | Fiber | Fiber |
| | | P4 | R4 | P5 | R5 | P6 | R6 |
| | Yarn count (S) | 20 | 40 | 20 | 40 | 20 | 40 |

### Embodiment 4

If a speaker damper composed of various material of fibers, such as polyester fibers, rayon fibers, aramid fibers, cotton fibers, in specific ratio is to be composed, the conventional manufacturing method requires first preparing the various materials of fibers, mixing and twisting the fibers with a specific ratio into yarns, and using the yarns as warps and wefts to be woven to obtain a fabric material with a specific material ratio and yam count. This process of mixing and twisting various materials has a higher processing expense than the process of mixing and twisting only two materials. In addition, this type of speaker damper with special material ratio specified by a speaker damper factory must be customized. As a result, the manufacturing cost of the speaker damper is higher.

Referring to FIG. 5D, FIG. 5D shows a partial enlarged view of Embodiment 4. In Embodiment 4, the total number of threads and the material composition ratios of the warps and wefts required can be achieved by collocating material fibers with different compositions and using specified number of threads ratio and arrangement order.

Taking Embodiment 4 as the example, the warps are composed by sequentially and alternatively arranging polyester/rayon double-stranded fibers PR (yarn count of 20), polyester fibers P (yarn count of 40), aramid/polyester double-stranded fibers AR (yarn count of 20), rayon fibers R (yarn count of 20), and aramid/cotton double-stranded fibers AC (yarn count of 20). The polyester/rayon double-stranded fibers PR are composed of 50% polyester fibers and 50% rayon fibers, the polyester fibers are composed of 100% polyester fibers, the aramid/polyester double-stranded fibers AR are composed of 50% aramid fibers and 50% polyester fibers, the rayon fibers R are composed of 100% rayon fibers, and the aramid/cotton double-stranded fibers AC are composed of 50% aramid fibers and 50% cotton fibers.

The wefts are composed by sequentially and alternatively arranging polyester/rayon double-stranded fibers PR (yarn count of 20), polyester fibers P (yarn count of 40), aramid/polyester double-stranded fibers AR (yarn count of 20), rayon fibers R (yarn count of 20), and aramid/cotton double-stranded fibers AC (yarn count of 20). The polyester/rayon double-stranded fibers PR are composed of 50% polyester fibers and 50% rayon fibers, the polyester fibers are composed of 100% polyester fibers, the aramid/polyester double-stranded fibers AR are composed of 50% aramid fibers and 50% polyester fibers, the rayon fibers R are composed of 100% rayon fibers, and the aramid/cotton double-stranded fibers AC are composed of 50% aramid fibers and 50% cotton fibers (as shown in Table 4).

Embodiment 4 shows a further applicable example, in which various materials including polyester fibers, rayon fibers, aramid fibers and cotton fibers etc.

that can be applied as the speaker damper are taken to be used as 100% single yarns, or composite yarns (double-stranded, triple-stranded, quadruple-stranded, etc.) mixed and twisted by at least two materials with specific ratios, and arranged with different yarn counts. In addition to the possible combinations thereof, the sequential order in warps and wefts are sorted to mix and weave a fabric met with specific requirements as a fabric for manufacturing a speaker vibrating diaphragm. Although Embodiment 4 similarly uses double-stranded fibers, composite yarns (double-stranded, triple-stranded, quadruple-stranded fibers, etc.) that are non-customized and have a common material mixing ratio can be used so that the manufacturing cost is still lower than conventional customized yarns by mixing and twisting materials.

TABLE 4
Fiber composition and yarn counts of the warps and wefts in Embodiment 4

| warps | Fiber | Polyester + | Polyester | Aramid + | Rayon | Aramid + |
|---|---|---|---|---|---|---|
| | material/ | Rayon | Fiber P | Polyester | Fiber R | Cotton |
| | Number | Fiber | | Fiber | | Fiber |
| | | PR | | AR | | AC |
| | Yarn Count (S) | 20 | 40 | 20 | 40 | 20 |
| wefts | Fiber | Polyester + | Polyester | Aramid + | Rayon | Aramid + |
| | material/ | Rayon | Fiber P | Polyester | Fiber R | Cotton |
| | Number | Fiber | | Fiber | | Fiber |
| | | PR | | AR | | AC |
| | Yarn Count (S) | 20 | 40 | 20 | 40 | 20 |

The above description is only for illustrating the preferred embodiments of the present invention, but not for restricting the present invention in any forms. It is apparent to those skilled in the art that a variety of modifications and changes may be made without departing from the scope of the present invention which is intended to be defined by the appended claims.

What is claimed is:

1. A manufacturing method of a speaker vibrating diaphragm by controlling a ratio of fiber materials, the method comprising the steps of:
(A) fabric provision: providing a fabric interwoven by a plurality of warps and a plurality of wefts;
(B) impregnation: impregnating the fabric in a resin solution;
(C) drying: drying the fabric impregnated with resin solution;
(D) formation: pressing the dried resin-impregnating fabric to form a predetermined shape; and
(E) cutting: cutting the formed speaker vibrating diaphragm from the fabric;
wherein, each of the plurality of warps of the fabric has an individual yarn count and material composition, and each of the plurality of wefts of the fabric has an individual yam count and material composition; a total number of threads and a material composition ratio of the warps and wefts required for the vibrating diaphragm are achieved by controlling a combination of the yarn counts of the plurality of warps and the plurality of wefts.

2. The manufacturing method according to claim 1, wherein each of the plurality of warps is a single yam composed of 100% of a single material.

3. The manufacturing method according to claim 1, wherein each of the plurality of wefts is a single yarn composed of 100% of a single material.

4. The manufacturing method according to claim 1, wherein the plurality of warps are composite yams twisted by using at least two types of materials.

5. The manufacturing method according to claim 1, wherein the plurality of wefts are composite yams twisted by using at least two types of materials.

6. The manufacturing method according to claim 1, wherein the plurality of warps has at least one kind of yarn count and the warps are alternately arranged in a predetermined order.

7. The manufacturing method according to claim 1, wherein the plurality of wefts has at least one kind of yarn count and the wefts are alternately arranged in a predetermined order.

8. The manufacturing method according to claim 1, wherein the material of the plurality of warps is one or a combination selected from a group consisting of cotton, polyester, aramid, acrylic, rayon, and silk.

9. The manufacturing method according to claim 1, wherein the material of the plurality of wefts is one or a combination selected from a group consisting of cotton, polyester, aramid, acrylic, rayon, and silk.
